(19) United States
(12) Patent Application Publication
(10) Pub. No.: US 2014/0139088 A1
(43) Pub. Date: May 22, 2014

(54) TRANSPARENT TOUCH DISPLAYS FOR REFRIGERATOR DRAWERS

(71) Applicant: WHIRLPOOL CORPORATION, Benton Harbor, MI (US)

(72) Inventor: MICHAEL S. SEELEY, South Haven, MI (US)

(73) Assignee: Whirlpool Corporation, Benton Harbor, MI (US)

(21) Appl. No.: 13/683,391

(22) Filed: Nov. 21, 2012

(51) Int. Cl. G06F 3/041; F25D 23/00

(52) U.S. Cl. CPC G06F 3/041; F25D 23/00
USPC 312/404; 345/173

(57) ABSTRACT

Transparent touch displays for refrigerator drawers are disclosed. An example refrigerator drawer compartment to hold a refrigerator drawer includes a transparent panel forming a portion of the refrigerator drawer compartment, a transparent touch display embedded in the transparent panel to provide a user interface to control a function associated with the refrigerator drawer while allowing viewing of contents of the refrigerator drawer.

### FIELD OF THE DISCLOSURE

This disclosure relates generally to refrigerators, and, more particularly, to transparent touch displays for refrigerator drawers.

### BACKGROUND

Most refrigerators have one or more drawers that facilitate the storage of food items at temperatures and/or humidities that are different from the rest of the refrigerator. For example, a drawer used to store produce might be controlled to have a higher humidity than the rest of the refrigerator, or a drawer used to store meat and cheese might be controlled to have a lower temperature than the rest of the refrigerator. In some refrigerators, a user can individually control the temperature and/or humidity of each drawer. A refrigerator drawer has an open top face that allows a person to place items in the drawer and remove items from the drawer. When the refrigerator drawer is in a closed position, the open top face of the refrigerator drawer may be closed by a shelf positioned above the drawer, the bottom of another drawer, or any other structure(s) of the refrigerator such as the refrigerator inner liner and/or interior partitions. The shelf, the bottom of another drawer and/or the other structure(s) define a refrigerator drawer compartment for the refrigerator drawer.

### SUMMARY

An example refrigerator drawer compartment to hold a refrigerator drawer includes a transparent panel forming a portion of the refrigerator drawer compartment, a transparent touch display embedded in the transparent panel to provide a user interface to control a function associated with the refrigerator drawer while allowing viewing of contents of the refrigerator drawer.

An example refrigerator includes a refrigerator cabinet, a refrigerated compartment disposed within the refrigerator cabinet, a drawer disposed within the refrigerated compartment, and a transparent touch display forming a portion of the refrigerated compartment to provide a user interface that enables a user to control a function associated with the refrigerator drawer while allowing the user to view contents of the drawer.

An example method includes presenting on a transparent touch display embedded in a transparent portion of a refrigerator drawer compartment a user interface to enable a user to control a function associated with a refrigerator drawer while allowing viewing of contents of the refrigerator drawer.

An example refrigerator drawer includes a transparent panel forming a portion of the refrigerator drawer compartment, and a transparent touch display embedded in a surface of the refrigerator drawer to provide a user interface to control a function associated with the refrigerator drawer while allowing viewing of contents of the refrigerator drawer.

### BRIEF DESCRIPTION OF THE DRAWINGS

FIG. 1 is a perspective drawing of an example refrigerator having an embedded transparent touch display.

FIG. 2 is a perspective drawing of the example refrigerator drawer stack of FIG. 1.

FIG. 3 is a perspective drawing of the example refrigerator drawer stack of FIG. 1 when the embedded transparent touch display of FIG. 2 is active.

FIGS. 4-6 illustrate example user interfaces that can be presented on the embedded transparent touch display of FIGS. 2 and 3.

### DETAILED DESCRIPTION

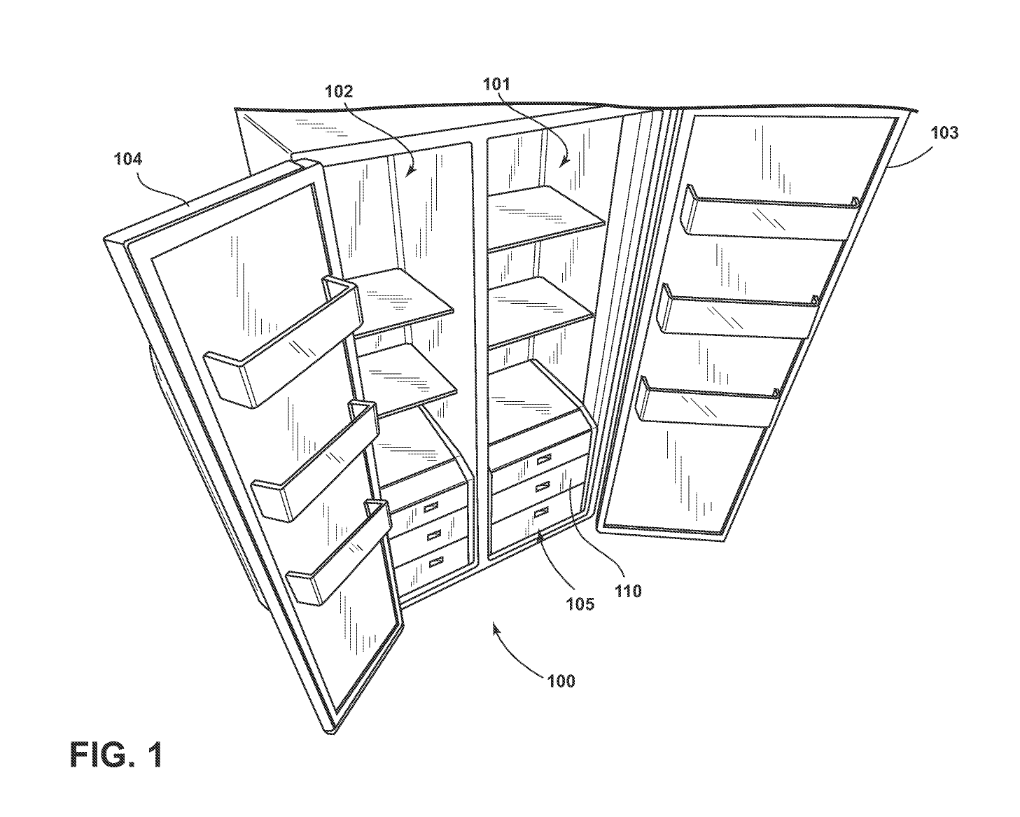

FIG. 1 illustrates an example refrigerator 100 having a refrigerated compartment 101 and a freezer compartment 102. The refrigerated compartment 101 and the freezer compartment 102 each have an open face to provide access to the compartments 101 and 102. The refrigerator 100 includes doors 103 and 104 moveably mounted to the refrigerator 100 for movement between opened and closed positions to selectively open and close the open faces of the compartments 101 and 102. While the example refrigerator 100 shown in FIG. 1 is a side-by-side refrigerator, it should be appreciated that the transparent touch displays for refrigerator drawers disclosed herein are applicable to other refrigerators having other configurations.

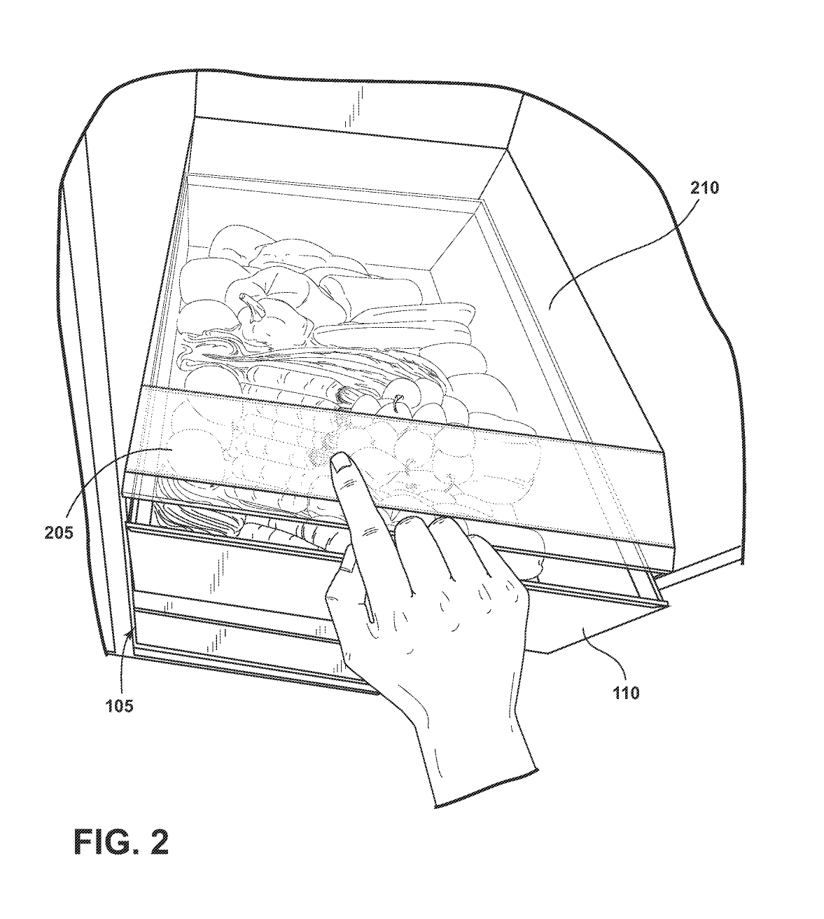

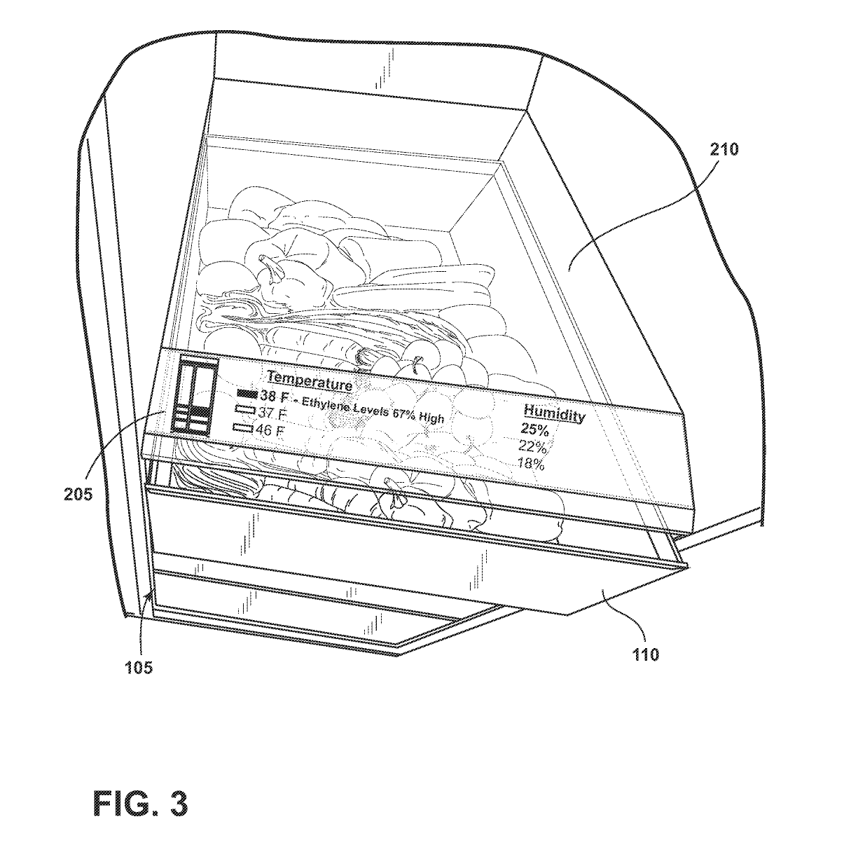

To allow food to be stored at different humidities and/or temperatures, the example refrigerator 100 includes a refrigerator drawer stack 105 having one or more transparent refrigerator drawers (one of which is designated at reference numeral 110). As discussed below in connection with FIGS. 2 and 3, the refrigerator drawer stack 105 includes a transparent touch display 205. Of course, the transparent touch displays for refrigerator drawers disclosed herein are applicable to other refrigerators having other arrangements of refrigerator drawers.

To control the transparent touch display 205, the refrigerator 105 may include a controller (not shown). The controller may be implemented by one or more Intel®, AMD®, and/or ARM® microprocessors. Of course, other processors from other processor families and/or manufacturers are also appropriate. The controller executes coded instructions present in a main memory of the controller.

FIG. 2 is a perspective drawing showing the example drawer stack 105 of FIG. 1 in more detail. To enable a user to view information about and/or control functions of the refrigerator drawers 110, the example drawer stack 105 of FIG. 1 includes the transparent touch display 205 embedded in a transparent portion 210 of a refrigerator drawer compartment. The transparent portion 210 may be formed of glass, plastic, crystal and/or a composite material. In FIG. 2, the transparent touch display 205 is inactive and thus nothing is displayed. In FIG. 3, the transparent touch display 205 is active and displaying information and receiving inputs. As shown in FIGS. 2 and 3, items stored in the drawers 110 can be viewed through the transparent touch display 205. The transparent touch display 205 may be a transparent touch organic light-emitting diode (OLED) display, a transparent touch liquid crystal display (LCD), etc.

In some examples, the transparent touch display 205 is activated when the transparent touch display 205 is touched as shown in FIG. 2. Alternatively, the transparent touch display 205 may be automatically activated when the door 103 (FIG. 1) is opened. As shown in FIGS. 2 and 3, the transparent touch display 205 may be embedded in an angled portion of the transparent portion 210. Alternatively, the transparent touch display 205 may be embedded in a flat portion of the transparent portion 210, or in a transparent front face of the drawer 110.

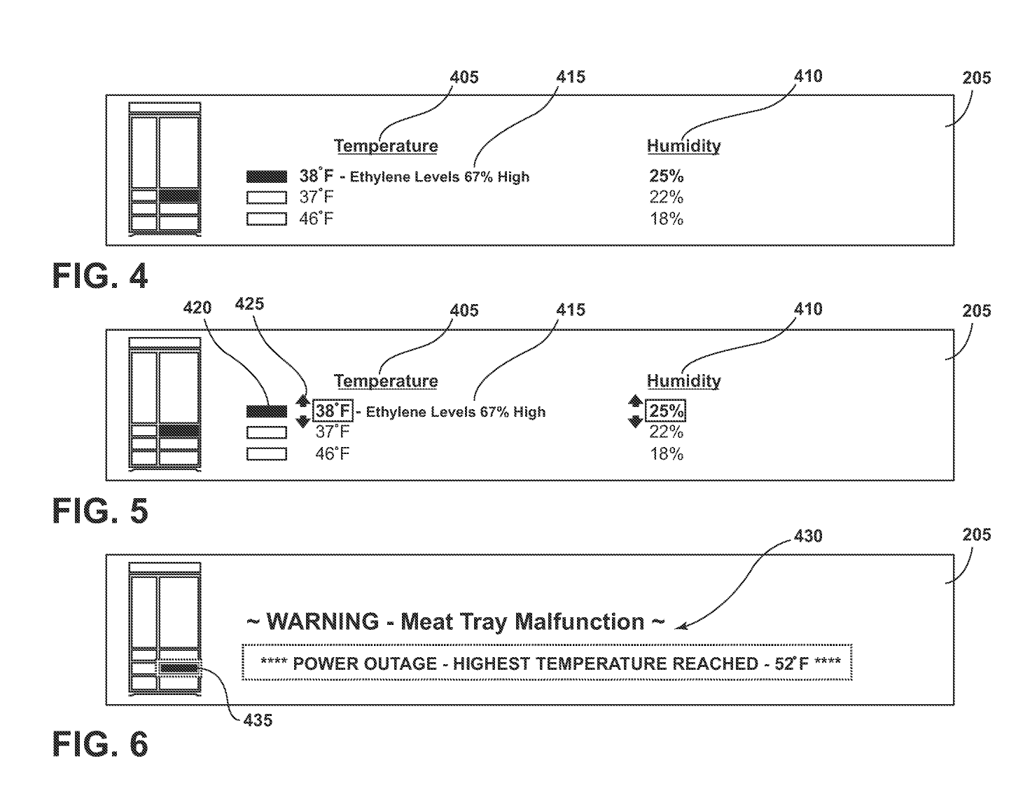

As discussed below in connection with FIGS. 4-6, the transparent touch display 205 may be used to control functions and/or display information for a plurality of drawers. Alternatively, if a transparent touch display 205 was embedded in the front of each refrigerator drawer 110, each transparent touch display 205 needs to only control functions and/or display information for its respective drawer 110.

FIGS. 4-6 illustrate example user interfaces that may be presented on the example transparent touch display 205. The user interfaces may: include color or be black-and-white; may include animations; and/or be transparent or opaque. The example user interface of FIG. 4 presents the temperature 405 and humidity 410 of each of three refrigerator drawers 110. The example user interface can present additional and/or alternative information. For example, as shown, the user interface can display ethylene levels, and/or a high ethylene level warning 415. Moreover, carbon-dioxide (CO₂) levels may also be displayed

The example user interface of FIG. 5 illustrates the use of the example user interface 205 of FIG. 4 to control one or more functions of the refrigerator drawers 110. As shown, if a top icon 420 is selected by touching the top icon 420, the temperature 405 and the humidity 410 become parameters that can be adjusted by touching corresponding up and down arrows 425.

The example user interface of FIG. 6 presents a temperature warning 430 indicating that a meat drawer 435 of the refrigerator reached an unsafe temperature due to, for example, a power outage, compressor failure, etc.

While example user interfaces are shown in FIGS. 4-6, it should be appreciated that any number and/or type(s) of additional and/or alternative user interfaces could be presented on the transparent touch display 205. Such additional and/or alternative user interfaces may display other types of data and/or enable the control of other functions of a refrigerator drawer. In some examples, a user may configure what information is displayed.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A refrigerator drawer compartment to hold a refrigerator drawer, comprising:
a transparent panel forming a portion of the refrigerator drawer compartment; and
a transparent touch display embedded in the transparent panel to provide a user interface to control a function associated with the refrigerator drawer while allowing viewing of contents of the refrigerator drawer.

2. A refrigerator drawer compartment as defined in claim 1, wherein the transparent touch display is to provide on the transparent touch display information associated with the drawer.

3. A refrigerator drawer compartment as defined in claim 2, wherein the information displayed comprises an ethylene level.

4. A refrigerator drawer compartment as defined in claim 2, wherein the information displayed comprises a warning that a temperature in the drawer has exceeded a threshold.

5. A refrigerator drawer compartment as defined in claim 1, wherein the transparent panel comprises a shelf that is to close an open face of the refrigerator drawer when the refrigerator drawer is in a closed position.

6. A refrigerator drawer compartment as defined in claim 1, wherein the function comprises at least one of a temperature or a humidity.

7. A refrigerator comprising:
a refrigerator cabinet;
a refrigerated compartment disposed within the refrigerator cabinet;
a drawer disposed within the refrigerated compartment; and
a transparent touch display forming a portion of the refrigerated compartment to provide a user interface that enables a user to control a function associated with the refrigerator drawer while allowing the user to view contents of the drawer.

8. A refrigerator as defined in claim 7, further comprising a controller operatively connected to the transparent touch display and configured to provide on the transparent touch display information associated with the drawer.

9. A refrigerator as defined in claim 8, wherein the information displayed comprises an ethylene level.

10. A refrigerator as defined in claim 8, wherein the information displayed comprises a warning that a temperature in the drawer has exceeded a threshold.

11. A refrigerator as defined in claim 7, wherein the transparent touch display is embedded in a shelf that is to close an open face of the refrigerator drawer when the refrigerator drawer is in a closed position.

12. A refrigerator as defined in claim 7, wherein the function comprises at least one of a temperature or a humidity.

13. A method comprising presenting on a transparent touch display embedded in a transparent portion of a refrigerator drawer compartment a user interface to enable a user to control a function associated with a refrigerator drawer while allowing viewing of contents of the refrigerator drawer.

14. A method as defined in claim 13, further comprising providing on the transparent touch display information associated with the refrigerator drawer.

15. A refrigerator as defined in claim 14, wherein the information displayed comprises an ethylene level.

16. A refrigerator as defined in claim 14, wherein the information displayed comprises a warning that a temperature in the drawer has exceeded a threshold.

17. A refrigerator drawer comprising:
a transparent panel forming a portion of the refrigerator drawer compartment; and
a transparent touch display embedded in a surface of the refrigerator drawer to provide a user interface to control a function associated with the refrigerator drawer while allowing viewing of contents of the refrigerator drawer.

18. A refrigerator drawer compartment as defined in claim 17, wherein the transparent touch display is to provide on the transparent touch display information associated with the drawer.

19. A refrigerator drawer compartment as defined in claim 18, wherein the information displayed comprises an ethylene level.

20. A refrigerator drawer compartment as defined in claim 18, wherein the information displayed comprises a warning that a temperature in the drawer has exceeded a threshold.
